(19) United States
(12) Patent Application Publication
(10) Pub. No.: US 2003/0126096 A1
(43) Pub. Date: Jul. 3, 2003

(54) Graduated revenue business model for content creators and recommenders

(76) Inventor: Daniel Pelletier, Lake Peekskill, NY (US)

Correspondence Address: PHILIPS ELECTRONICS NORTH AMERICAN CORP, 580 WHITE PLAINS RD, TARRYTOWN, NY, 10591, US

(21) Appl. No.: 10/034,473

(22) Filed: Dec. 28, 2001

(51) Int. Cl. G06F 17/60

(52) U.S. Cl. 705/400

(57) ABSTRACT

A method for providing a graduated revenue stream to recommenders of at least one of products and services (P/S) comprising the steps of (a) providing a central site that provides information and permits purchasing with regard to at least one of products and services (P/S); (b) determining whether a customer query/purchase is based on a recommendation; (c) providing the customer query/purchasing with one of: (i) a base price if the query/purchase in step (b) is not based on a recommendation; and (ii) a base price plus adding of an incremental value i to the base price if there has been a recommendation; and (d) paying a percentage of the incremental value i to a first recommender R1.

### BACKGROUND OF THE INVENTION

1. Field of the Invention

The present invention relates to a business method. More particularly, the present invention relates to a graduated revenue business model that incorporates the use of the Internet to provide the graduated revenue business model.

2. Description of the Related Art

In the prior art, business models have recognized the value of providing incentives as a means to increase productivity, particularly among a sales force that often is compensated on a commission and/or bonus plan.

It is also known that there are business models referred to as “pyramids” wherein an original group of investors receives returns from subsequent investors, and in turn the subsequent investors receive returns from investors that enter the pyramid even later than the subsequent investors. However, pyramids in general are illegal because of the failure to provide returns to those who join the pyramid relatively late in the process. The conventional thinking about pyramids is often tied in to reports about investment clubs, which often do not invest the money to earn legitimate returns for the club members but instead use the funds for personal gain. Initially unusually high returns are paid to the first group of investors so as to entice more people to join.

However, the present inventor also recognizes the advantage to the timing of making a purchase or investment. Whether that investment be real estate, mutual funds, stocks, to name only a few items.

In addition, with the advent of advanced telecommunication and the Internet, the ability to increase demand for a product where a service can be enhanced by the advent of recommendations in which the recommenders are compensated. This contrasts with prior art web sites, such as Napster or Amazon, which do not provide any pecuniary gain or incentive to participants in the ratings.

### SUMMARY OF THE INVENTION

Therefore, it is an object to the present invention to provide a method for a graduated revenue stream that provides an incentive to purchase a product or service at a lower price than may be paid by future purchasers, and to receive exponential benefits on future sales provided by gradually higher priced sales of the product or service to the subsequent purchasers.

### BRIEF DESCRIPTION OF THE DRAWINGS

FIGS. 1A and 1B are a flow chart illustrating an overview of the process of the present invention.

FIG. 1C is a flow chart illustrating a variation of the process depicted in FIGS. 1A and 1B.

FIG. 2 provides more details in flowchart form of an embodiment of the process illustrated in FIGS. 1A and 1B.

FIG. 3 is an overview of how recommendations can be made, and how the purchaser can browse the website.

### DETAILED DESCRIPTION OF THE PREFERRED EMBODIMENTS

It is understood by persons of ordinary skill in the art that the following embodiments are presented for purposes of illustration and not for limitation. An artisan understands there are various modifications of the illustrated embodiments that are within the spirit of the invention and the scope of the appended claims.

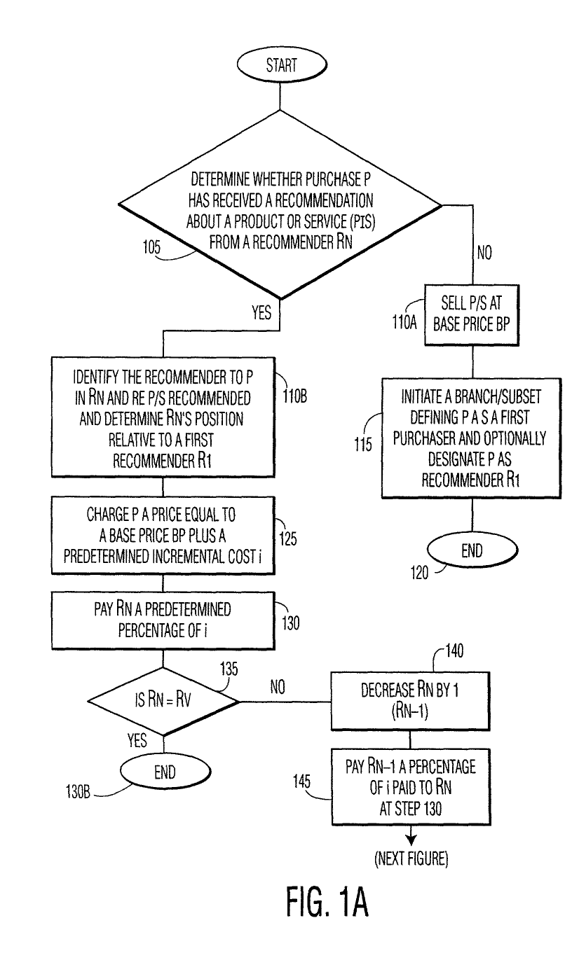

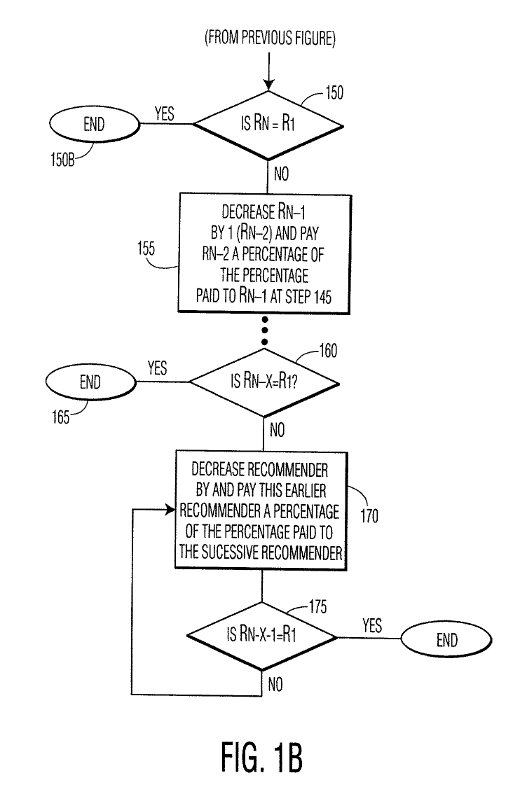

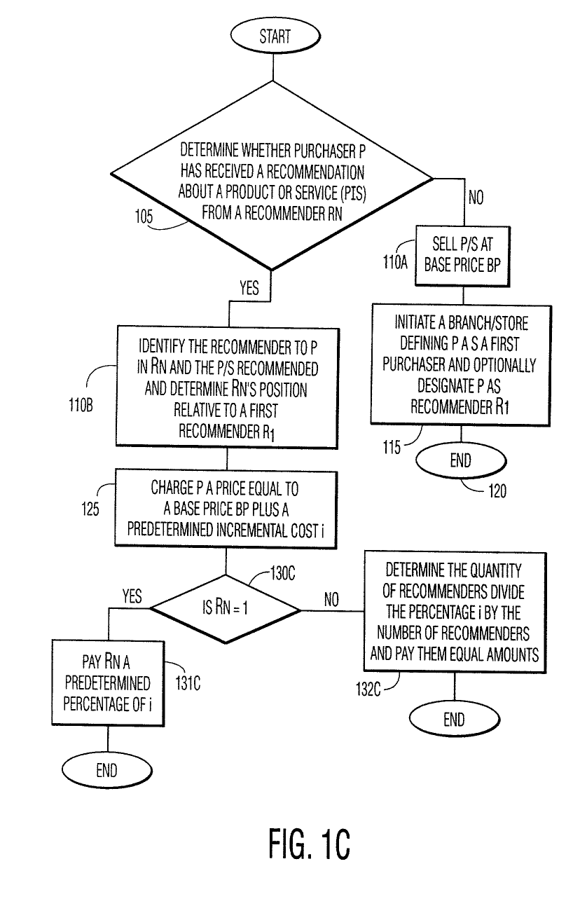

FIGS. 1A and 1B illustrates a flow chart providing an overview of the present invention. For explanatory purposes, the type of product or service is generic. Further detail about the specific uses are provided in subsequent passages.

At step 105, there is a determination whether a purchaser P has received a recommendation about a product or service (P/S) from a recommender Rn in response to either a purchaser's query as to the price of the product or service (P/S) or the indication that the purchaser wants to purchase the item without asking for the price.

The determination in step 105 can be made by providing an identifying code of the P/S where the recommender Rn makes the recommendation. This would allow identification of the actual recommender of the product or service.

Alternatively, each recommender Rn can provide a list of potential purchasers indicating who received recommendation about a product or service. This list can be stored in a central system and/or storage area, typically a server on a network. The list will be cross-referenced to identify the purchaser P and the recommender each time a purchase is made. However, when more than one recommender (i.e. multiple recommenders) have recommended a product or service to purchaser P, there is a potential conflict in that one recommender might be ranked at a different level than another recommender, and a decision would need to be made regarding the price charged and commission paid to the recommenders. While there is more than one way that this problem can be solved, it is preferable to charge the purchaser P the lowest price from the among the multiple recommenders that could be charged, and to split the commission evenly among the recommenders. Thus, regardless of their position, in the case of multiple recommenders for purchaser P, the commission would be the same.

This approach is felt to be the fairest, since there is no way of determining which of the reommendations actually made the purchaser P decide to purchase, or to try to apportion credit for the purchase in a fashion other than equal fractions. This embodiment is depicted in FIG. 1C, wherein after a determination is made (at step 130C) that there is more than one recommender, the commission (i.e. percentage of i) is split evenly (Step 132C).

If the determination made in step 105 is that there was no recommender (in another words, P decided to purchase without any direct recommendation) then at step 110A, purchaser P charged a base price (BP). This base price has been predetermined for purchasers who have not received a recommendation.

In addition, at step 115 the purchaser P, who has not received a recommendation, is recorded by the server as being a first recommender R1 for products or services associated with other potential purchases.

Without any previous recommenders, at step 120 the process would stop.

If the determination at step 105 is that there was a recommendation, then at step 110B there is a further determination to identify the position of the recommender Rn. For example, if Rn=3, this is the third recommender in succession for a particular subset or branch.

It should be noted that for every product or service recommended R1 would directly recommend, or indirectly recommend (meaning that R1 recommended the product or service to R2, who then recommended the product or service to R3). Thus, R2 is an intervening recommender between R1 and R3 (f or example) and is also subsequent recommender to R1.

According to this embodiment at step 110B, if Rn=R1: the purchaser P would be charged a price equal to the base price (BP) plus i a predetermined increment. Typically, the increment would be a small amount related to the base price.

In addition, if Rn=R2: the purchaser would be charged a price equal to the base price (BP) plus 2i. Similarly, if Rn=R3: the purchaser would be charged BP plus 3i, etc.

It is preferred that i eventually would reach a limit were it would not be further increased and such an amount would be set by the user.

At step 125, the recommender Rn receives a percentage “p” of the incremental cost i. For purposes of illustration and not for limitation, for example, a percentage of i paid to Rn (which could range up to 100%) is 10% in this case. In addition, for explanatory purposes only, assume the amount of the i=25 cents. Thus, Rn would get 10% of i (25 cents)=2.5. The 2.5 cents would be paid for each purchase from purchaser P made after a direct recommendation (meaning no intervening recommenders) from Rn.

At step 130, it is determined whether Rn=R1 (meaning that Rn is the first recommender in a branch). If Rn is equal to R1, the process ends at 130B. If R however at step 135, if Rn is not equal to R1, the value of Rn is decreased by 1 (now Rn−1).

At step 140, Rn−1 is paid a percentage of the percentage paid to Rn at step 125. In the above example, Rn received 2.5 cents which is 10% of i. Rn−1 can receive for example 10% of what Rn received, meaning 10% of 2.5 cents or 0.25 cents, according to the above example. It should be understood by an artisan that the percentages do not have to correspond (e.g. Rn−1 could receive 13% of what Rn receives).

At step 145, it is determined whether Rn−1 is equal to R1. If the answer is yes, the process ends at step 150B. However, if Rn−1 is not equal to R1, Rn−1 is decreased by 1 (becoming Rn−2).

At step 155, Rn−2 is paid a percentage of the percentage paid to Rn−1 from step 140. For example, if Rn−1 gets 0.25 cents, then Rn−2 may get 10% of what Rn−1 receives, or 0.025 cents.

At step 160, it is determined whether Rn−x is equal to R1. If they are equal, the list of recommenders for that subset/branch is exhausted and the process ends at step 165, as all of the recommenders have been compensated.

However, if Rn−x is not equal to R1, the process continues on as indicated by the dots. At step 170, a recommender (Rn−x−1 is paid a percentage of the percentage paid to Rn−x).

Also at step 170, it is determined whether Rn−x−1=R1. If they are equal, the process ends at step 175. If they are not, the process loops back to step 170 where the recommender value is decreased by 1 and the process will continue until the first recommender has been reached.

By performing this process, the graduating selling price is akin to steps in a pyramid, meaning that the first customer pays the lowest price, and the additional customers that buy on recommendation pay additional amounts that can be used to compensate all of the recommenders.

In another variation of the above embodiment, the price increases may be consistent with thresholds. For example, once the product for service reaches a certain predetermined number of sales (say 1,000) the price increases to a certain value. Then when 10,000 sales are made, the price may increase to a different value. In such a case, under the base price (BP) could be used to have different thresholds, or the incremental amount could be a fixed nominal value that increases after the thresholds are reached.

There needs to be a prohibition of a potential purchaser attempting to purchase an item as an unsolicited/unrecommended purchaser (then becoming an R1) when they have previously received or reviewed recommendations about a product or service. One way this could be accomplished is by marking information on a cookie on the user's hard drive, and updating the cookie each time they read a recommendation. However, there is nothing impeding a more savvy computer user from either turning off the cookie feature on their computer, or erasing the cookies from storage, or even using one computer to read recommendations and another to purchase. This would be somewhat analogous to, for example, trying to circumvent an employment recruiter's fee by not acknowledging that the person's resume came through the recruiter.

Another way this prohibition of circumventing commissions could be accomplished is to have users register on the website so that if they should read recommendations, it would be tracked by the website. However, sometimes potential purchasers do not want to offer personal information out of concern that the website might be collecting same for sale/use for other solicitations. Accordingly, a userid may be all that is generated prior to permitting browsing of the system, and all recommendations read, or sent to that userid, would need to be tracked to prevent someone from entering as non-recommended, even though they were actually recommended. It is also possible to use an identifier, such as included in Intel Pentium III™ microprocessors, to track users accessing the website. Also, the ISP could relay the telephone number used to dial into the ISP by a caller-id type system, but this method would probably be difficult to persuade an ISP to agree to, as the telephone number of a user may be considered confidential.

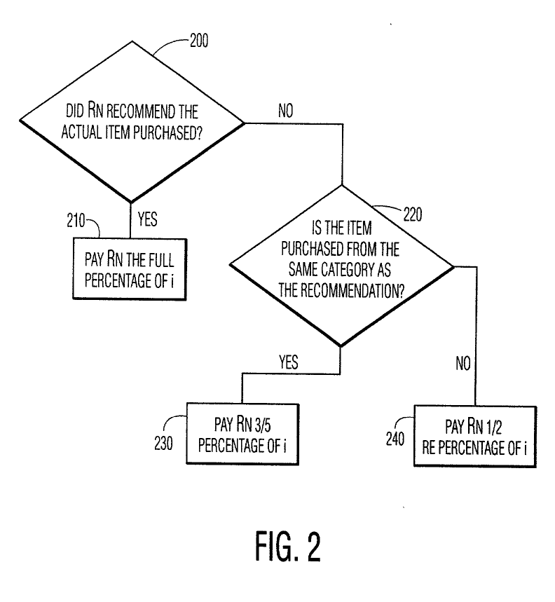

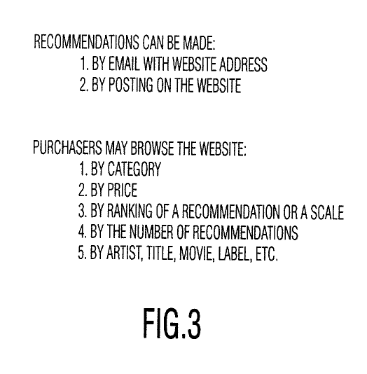

FIG. 2 shows how another embodiment of the invention can include readings for products or services from which recommenders provide ratings that are categorized within different genres and categories including price.

The different categories can affect the amount of compensation to the recommenders. For example, at step 200 it is determined whether or not Rn recommended that actual item purchased by P. If yes, at step 210 Rn is paid the full percentage of i. If no, at step 220 it is determined whether or not the item purchased by P is from the same category as the recommendation. If yes, at step 230 Rn is paid less than the full percentage of i (for explanatory purposes FIG. 2 shows ⅗ but it could be any fraction). At step 240 the item purchased is not from the same category, so Rn is paid, for example, ½ the percentage of i. One example is that Rn recommends a record album from the Beatles named Abbey Road. If purchaser P purchases the Beatles album Abbey Road Rn receives the full percentage of i. However, if the purchaser selects the Beatles album entitled “Magical Mystery Tour”, Rn could be paid a lesser percentage of i, perhaps ⅗. On the other hand, if the purchaser P purchases an album of marching band songs by John Philips Sousa, Rn could be paid a lesser percentage of i because the category of music is different than the rock and roll type recommended by recommender Rn. Of course, the system may be fine tuned as needed, with various divisions, subdivisions, categories or genres as desired. For example, the recommender could recommend the Beatles album Magical Mystery Tour, but the purchaser may decide to purchase the movie made by the Beatles of the same name instead of the album. The purchase of the movie, which would be considerably more expensive than the songs of just the sound track, and in such an instance, the recommender could even receive additional amounts of compensation. Of course, the incremental amount may be quite different for a movie than that of an album or a single song, and the system may be fine tuned according to need.

In an embodiment, it is also envisioned that the present invention can be an Internet Web Site that recommends items, such as Napster recommends music. Unlike Napster, the present invention would provide a return to those who recommend music that they like, when that music is then purchased by others in their peer group after reading a recommendation.

It is also envisioned that in addition to albums and/or movies, performers, producers, record companies, writers, etc. could all be categorized with recommendations. In addition, price can be included as one of the categories.

So in other words, a potential purchaser can look for positive recommendations of country music by a cost of a CD, and/or the downloading of an individual song or songs is limited by price.

In addition, purchasers can check for recommendations according to the category of up and coming songs by unknown artist, or by a specific artist, so as to attempt to recommend an item that will ultimately become popular.

The ability to successfully recognize popular songs/movies etc. in the early stages allows recommenders to make huge profits from successfully identifying hits in their infancy.

Accordingly, according to the present invention, the process provides a fluid demand driven mini economy, where people who are good at spotting potentially successful items can get significant rewards recommending the items to other in the early stages of sales.

In addition, people that shop for these items will have the ability to purchase items that could be inexpensive and risky, or more expensive and market tested. Recommenders who are sure of the winning potential of the items can use their own sources to advertise in order to increase their sales and ultimately the recommenders return.

It is understood by persons of ordinary skill in the art how to set up a website that would permit the posting of recommendations, and the tracking of purchases after reading the recommendation. The recommender may also rank on a scale (say for 1 t 5 or 1 to 10) so that a purchaser can browse, for example, for a song having the most “10” ratings in a category.

What is claimed is:

1. A method for providing a graduated revenue stream to recommenders of at least one of products and services (P/S) comprising the steps of
(a) providing a central site that provides information and permits purchasing with regard to at least one of products and services (P/S);
(b) determining whether a customer query/purchase is based on a recommendation;
(c) providing the customer query/purchasing with one of:
(i) a base price if the query/purchase in step (b) is not based on a recommendation; and
(ii) a base price plus adding of an incremental value i to the base price if there has been a recommendation; and
(d) paying a percentage of the incremental value i to a first recommender R1.

2. The method according to claim 1, wherein there are a plurality of successive recommenders for a product/service purchased by purchaser P, wherein the purchaser P pays the lowest incremental value i in addition to the base price regardless of a position of the plurality of recommenders, and each one of the plurality of successive recommenders receives an equal percentage of the incremental value i.

3. The method according to claim 1, wherein there are a plurality of successive recommenders, and wherein a latest recommender is paid a largest percentage of incremental value i and each previous recommender is paid a percentage of the percentage paid to the latest recommender.

4. The method according to claim 3, wherein the first recommender receives a percentage of the percentage of all recommendations made by successive recommenders.

5. The method according to claim 1, wherein when no recommendation has been made in step (c), defining P as the first recommender R1 in a new branch for the (P/S).

6. The method according to claim 1 wherein the central site provided in step (a) comprises a website.

7. The method according to claim 3, wherein the plurality of recommendations are posted on a website.

8. The method according to claim 3, wherein the recommendations are emailed to the customer.

9. The method according to claim 8, wherein the email message contains hypertext which provides identifying information about the recommender to the central site when the customer queries/purchases a P/S.

10. The method according to claim 3, wherein the incremental value added to the base price is based on a count of purchases of the P/S by a particular group of the plurality of recommenders.

11. The method according to claim 6, wherein the (P/S) comprises music.

12. The method according to claim 6, wherein the P/S comprises movies.

13. The method according to claim 7, wherein the plurality of recommendations are categorized by at least one of price, and type of P/S.

14. The method according to claim 7, wherein the plurality of recommendations are categorized by qualitative ratings by the recommenders.

15. The method according to claim 13, wherein the P/S is categorized by one of artist, group name, and recording label.

16. The method according to claim 1, wherein the P/S is downloaded to the customer via the central site.

17. The method according to claim 1, wherein the incremental value i is increased according to predetermined thresholds.

18. The method according to claim 17, wherein the predetermined threshold comprises number of sales.

19. The method according to claim 17, wherein when a particular P/S is not specifically recommended but is part of a predetermined category, the incremental amount i paid to a recommender is less than if the P/S were specifically recommended.

20. The method according to claim 7, further comprising providing customer query of recommenders having a highest correlation of recommendations for popular P/S, wherein popularity is defined by predetermined commercial thresholds.
